(19) United States
(12) Patent Application Publication
(10) Pub. No.: US 2010/0123906 A1
(43) Pub. Date: May 20, 2010

(54) FACSIMILE MACHINE WITH MULTIPLE LINES AND IMAGE FORMING APPARATUS COMPRISING THE SAME

(75) Inventors: Inn HAHM, Suwon-si (KR); Young-sang Seo, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/542,022

(22) Filed: Aug. 17, 2009

(30) Foreign Application Priority Data
Nov. 18, 2008 (KR) 10-2008-0114770

(51) Int. Cl. G06K 15/22

(52) U.S. Cl. 358/1.4

(57) ABSTRACT

An image forming apparatus is equipped with a facsimile machine having two or more lines, including a paper feeding unit; an image forming unit; and a discharging unit, wherein if first facsimile information is received through a first line of the two or more lines, the paper on which an image of the first facsimile information is formed is discharged passing through the paper feeding unit, a paper transporting path and the discharging unit in turn, and if second facsimile information is received through a second line of the two or more lines, the paper on which an image of the second facsimile information is formed is discharged passing through a paper returning path, the paper transporting path and the discharging unit in turn after the image of the second facsimile information has been formed.

### CROSS-REFERENCE TO RELATED APPLICATIONS

This application claims priority from Korean Patent Application No. 10-2008-0114770, filed on Nov. 18, 2008, in the Korean Intellectual Property Office, the disclosure of which is incorporated by reference in its entirety.

### BACKGROUND OF THE INVENTION

1. Field of the Invention

Aspects of the present invention relate to an image forming apparatus equipped with a facsimile machine having multiple lines, and more particularly, to a multi-functional apparatus having a multi-line facsimile function.

2. Description of the Related Art

Image forming apparatuses having at least two or more features of a photocopier, facsimile, scanner and printer (hereinafter referred to as “multi-functional apparatus”) have been increasingly used.

Recently, as a growing number of intelligent apparatuses have been networked with each other, the amount of data to be processed has accordingly increased. Therefore, in order to facilitate handling of input and output data, diverse technologies have been applied to improving paper feeding trays and paper discharging trays. For example, a paper discharging tray may be configured such that a large amount of paper can be discharged thereon, or a plurality of paper discharging trays may be provided, among which a tray may be automatically selected according to the document to be output. In addition, where a larger amount of documents exceeding any predetermined capacity to load are to be loaded on the paper discharging tray, the output documents exceeding the predetermined capacity may be loaded onto another paper discharging tray. In addition, a particular paper discharging tray may be selected according to a particular function of facsimile or photocopying.

Medium- and large-sized multi-functional apparatuses currently under development have increasingly employed multi-line facsimile machines. In particular, it may be desirable to use two lines: commercial and private, or internal and external, Line “A” and Line “B,” etc. In addition, a single multi-functional apparatus may be commonly used by two or more departments in a company, with each department being assigned its own use line. In each of these instances, it is desirable to sort and discharge the printouts based on each use line. With a multi-line facsimile machine that does not have a finisher such as a separate sorter, there is a risk that the multi-line facsimile machine may mixedly discharge the output documents received from the respective lines:. If a sorter is present, the output documents may be sorted by each use line and discharged to different paper discharging trays. However, a sorter adds to the size and cost of a multi-functional apparatus. Where use of the photocopying function or the printing function is not frequent, or where several users or departments do not use the multi-functional apparatus commonly, there is no need to additionally install a finisher or to purchase a high-end multi-functional apparatus equipped with the finisher.

Accordingly, a multi-functional apparatus capable of sorting and discharging printout documents by each use line without requiring an additional sorter or finisher is desirable.

In addition, in a multi-functional apparatus having a single line facsimile machine, it may be desirable to distinguish the printed documents from the faxed documents.

### SUMMARY OF THE INVENTION

Accordingly, aspects of the present invention provide a multi-functional apparatus that sorts and discharges printouts into a single receiving tray according to the source of the printing information that is printed, such as a first or second incoming line of a facsimile machine.

Another aspect of the present invention provides a multi-functional apparatus that allows printed documents from faxed documents to be distinguished even though the multi-functional apparatus has only a single line facsimile machine.

According to an embodiment of the present invention, there is provided an image forming apparatus equipped with a facsimile machine having two or more incoming lines, including a paper feeding unit that feeds a paper; an image forming unit that forms an image on the paper; a discharging unit that discharges the paper on which the image is formed; a paper transporting path on which the image forming unit is positioned, the paper transporting path extending from the paper feeding unit to the discharging unit; and a paper returning path that extends from the discharging unit to a point in the paper transporting path upstream of the image forming unit with respect to a movement direction of the paper, wherein if first facsimile information is received through a first line of the two or more incoming lines, the paper on which an image of the first facsimile information is formed passes from the paper feeding unit through the paper transporting path, where the image of the first facsimile information is formed, to the discharging unit, and if second facsimile information is received through a second line of the two or more incoming lines, different from the first line, the paper on which an image of the second facsimile information is formed passes from the paper feeding unit through the paper transporting path, where the image of the second facsimile information is formed, and then through the paper returning path, the paper transporting path a second time and to the discharging unit.

According to an aspect of the present invention, the paper returning path may include a two-sided printing functionality to form the image on both sides of the paper.

According to an aspect of the present invention, the both-side printing functionality may be set to be inactive.

According to an aspect of the present invention, the facsimile machine may have two lines.

According to another embodiment of the present invention, there is provided a method of operating an image forming apparatus that receives printing information from a first source and a second source and that discharges papers having an image formed thereon based on the received printing information to a single discharging tray, the method including determining whether printing information received by the image forming apparatus is from the first source or the second source; if the printing information is determined to be from the first source, forming an image on a paper according to the printing information from the first source and discharging the paper having the image according to the printing information from the first source formed thereon to the single discharging tray; and if the printing information is determined to be from the second source, forming an image on a paper according to the printing information from the second source and discharging the paper having the image according to the printing information from the second source formed thereon to the single discharging tray, wherein the forming of the image on a paper according to the printing information from the second source or the discharging of the paper having the image according to the printing information from the second source formed thereon is carried out such that the paper having the image according to the printing information from the second source is distinguishably oriented in the single discharging tray with respect to a paper having an image according to the printing information from the first source.

According to another embodiment of the present invention, there is provided an image forming apparatus equipped with a facsimile machine having two or more incoming lines, including a paper feeding unit that feeds a paper; an image forming unit that forms an image on the paper; a control unit that controls the image forming unit to form an image with respect to image information received from the facsimile machine on the paper; a discharging unit that discharges the paper on which the image is formed; a paper transporting path on which the image forming unit is positioned, the paper transporting path extending from the paper feeding unit to the discharging unit; and a two-sided printing path that extends from the discharging unit to a point in the paper transporting path that is upstream of the image forming unit with respect to a movement direction of the paper, such that a paper that has passed through the image forming unit a first time is directed to pass through the image forming unit a second time such that an image is formed on both sides of the paper, wherein if an image with respect to first image information received through a first line of the two or more incoming lines is formed on both sides of the paper, the control unit controls the image forming unit to form the image thereof on both sides of the paper based on the received first image information, and if an image with respect to second image information received through a second line of the two or more incoming lines, which is different from the first line, is formed on both sides of the paper, the control unit controls the image forming unit to form the image thereof on both sides of the paper based on third image information, which is rotated from the received second image information by 180 degrees.

According to another embodiment of the present invention, there is provided an image forming apparatus equipped with a facsimile machine having two or more incoming lines, including a paper feeding unit that feeds a paper; an image forming unit that forms an image on the paper; a control unit that controls the image forming unit to form an image with respect to image information received from the facsimile machine on the paper; a discharging unit that discharges the paper on which the image is formed, wherein if first image information to be printed is received through a first line of the two or more incoming lines, the control unit controls the image forming unit to form an image thereof on the paper based on the received first image information, and if second image information to be printed is received through a second line of the two or more incoming lines, which is different from the first line, the control unit controls the image forming unit to form an image thereof on the paper based on third image information, which is rotated from the received second image information by 180 degrees.

According to another embodiment of the present invention, there is provided an image forming apparatus having two or more functions of printing, photocopying and faxing, including a paper feeding unit that feeds a paper; an image forming unit that forms an image on the paper; a discharging unit that discharges the paper on which the image is formed; a paper transporting path on which the image forming unit is positioned, the paper transporting unit extending from the paper feeding unit to the discharging unit; and a paper returning path that extends from the discharging unit to a point in the paper transporting path that is upstream of the image forming unit with respect to a movement direction of the paper, wherein if an image is formed on the paper based on the facsimile function, the paper on which the image is formed passes from the paper feeding unit through the paper transporting path, where the image is formed based on the facsimile function, to the discharging unit, and if an image is formed on the paper based on the printing or photocopying function other than the facsimile function, the paper on which the image is formed passes from the paper feeding unit through the paper transporting unit, where the image based on the printing or photocopying function is formed, and then through the paper returning path and the paper transporting path a second time and to the discharging unit.

According to another embodiment of the present invention, there is provided an image forming apparatus equipped with a facsimile machine having two or more incoming lines, including a paper feeding unit that feeds a paper; an image forming unit that forms an image on the paper; a discharging unit that discharges the paper on which the image is formed; a paper transporting path on which the image forming unit is formed, the paper transporting path extending from the paper feeding unit to the discharging unit; and a two-sided printing path that extends from the discharging unit to a point in the paper transporting path that is upstream of the image forming unit with respect to a movement direction of the paper, such that a paper that has passed through the image forming unit a first time is directed to pass through the image forming unit a second time such that an image is formed on both sides of the paper, wherein if facsimile information received from a first line of the two or more incoming lines is printed on both sides of the paper, paper passes from the paper feeding unit through the paper transporting path and the two-sided printing path, then through the paper transporting path and the discharging unit, and where if facsimile information received from a second line of the two or more lines, which is different from the first line, is printed on both sides of the paper, the paper passes from the paper feeding unit through the paper transporting path and the two-sided printing path, and then through the paper transporting path, the two-sided printing path, the paper transporting path and the discharging unit.

According to another embodiment of the present invention, there is provided an image forming apparatus having two or more functions of printing, photocopying and faxing, including a paper feeding unit that feeds a paper; an image forming unit that forms an image on the paper; a discharging unit that discharges the paper on which the image is formed; a paper transporting path on which the image forming unit is formed, the paper transporting path extending from the paper feeding unit to the discharging unit; and a paper returning path that extends from the discharging unit to a point of the paper transporting path that is upstream of the image forming unit with respect to the movement direction of the paper, wherein if an image is formed on the paper based on printing or photocopying function, the paper on which the image is formed passes from the paper feeding path through the paper transporting path, where the image based on the printing or photocopying function is formed, to the discharging unit, and if an image is formed on the paper based on the facsimile function, the image is formed on the paper passing from the paper feeding unit through the paper transporting path, and the paper then passes through the paper returning path, the paper transporting path and the discharging unit.

According to another embodiment of the present invention, there is provided an image forming apparatus comprising an image forming unit that forms an image on a printing medium based on received printing information from a first source or a second source, the image forming unit including an image transferring roller; a single discharging tray that receives the printing medium having the image formed thereon; a first paper path that delivers the printing medium having an image formed thereon to the single discharging tray in a first orientation; a second paper path that delivers the printing medium having an image formed thereon to the single discharging tray in a second orientation; and a controller that determines whether received printing information is from the first source or the second source and directs the printing medium having an image formed thereon from the first source to be delivered to the single discharging tray by the first paper path and directs the printing medium having an image formed thereon from the second source to be delivered to the single discharging tray by the second paper path.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram showing that documents are outputted by each line in an image forming apparatus comprising a facsimile machine with two or more incoming lines; and

FIG. 2 illustrates a paper transporting path and a paper returning path in the image forming apparatus.

### DETAILED DESCRIPTION OF THE EMBODIMENTS

Reference will now be made in detail to the exemplary embodiments according to the present invention, examples of which are illustrated in the accompanying drawings, wherein like reference numerals refer to the like elements throughout. The embodiments are described below in order to explain the present invention by referring to the figures.

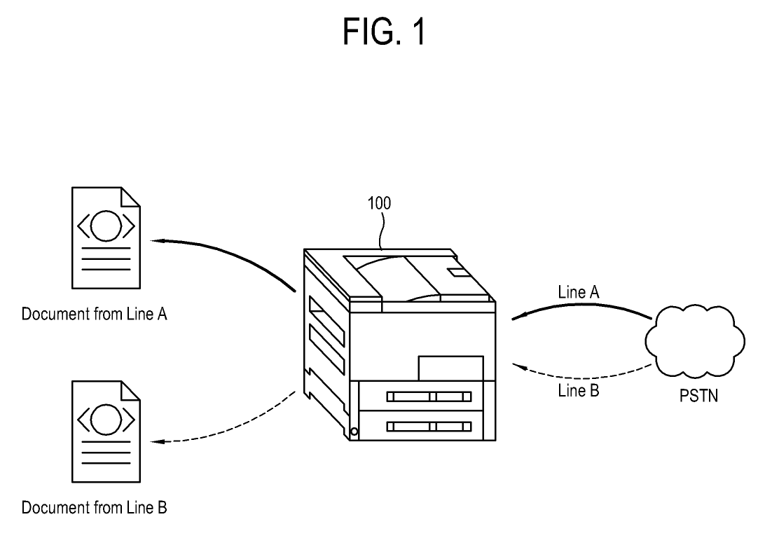

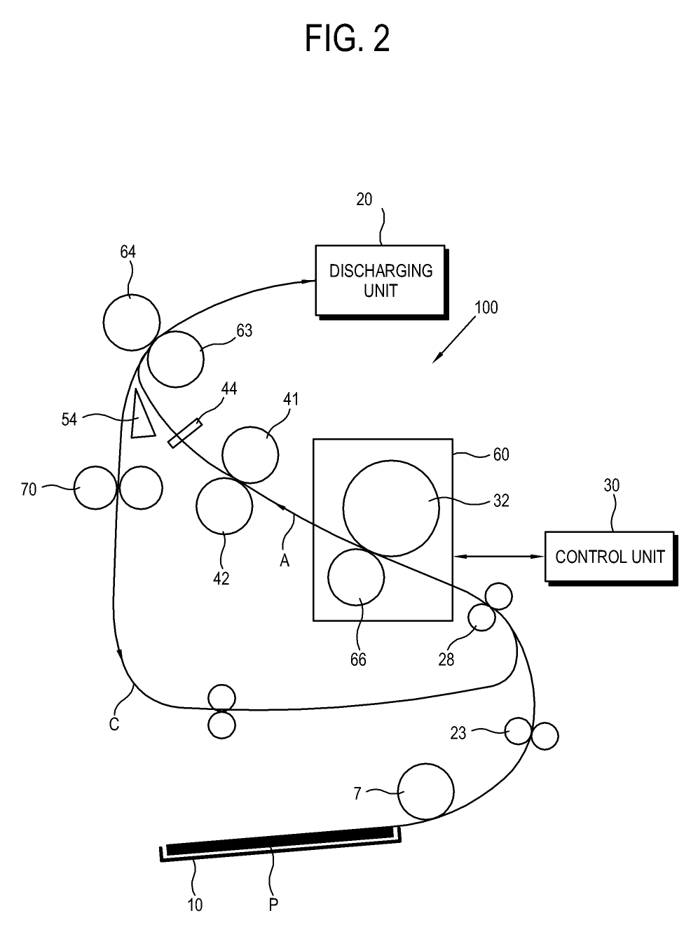

FIG. 1 schematically illustrates that documents are outputted according to facsimile information transferred in each incoming line in an image forming apparatus 100 comprising a facsimile machine with two or more lines, according to an exemplary embodiment of the present invention. The image forming apparatus 100 includes a facsimile machine (not shown) to perform a facsimile function. The facsimile machine according to an exemplary embodiment of the present invention may include a facsimile communication unit (not shown) performing communication with a receiver's facsimile machine to transmit and receive facsimile information, an image forming unit (see “60” of FIG. 2) forming an image of received facsimile information on a printing medium, and a scanner unit (not shown) performing scanning of an image formed on paper to be transmitted. The printing medium may be paper, particularly sheets of paper. However, it is to be understood other printing media can be used. In particular, any other printing medium, such as, for example, plastic or textile, that is in a form that can be fixed with a printed image can be used according to aspects of the present invention. Herein, for convenience and conciseness, the term “paper” is used throughout the specification instead of the term “print medium.” However, it is to be understood that the term “paper” is intended to include other types of print medium as well as sheets of paper.

The image forming apparatus 100 may be a multi-functional apparatus that can utilize at least one of the image forming unit and the scanning unit of the facsimile machine as a printer, a scanner or a photocopier. The facsimile machine (not shown) of the image forming apparatus 100 according to one exemplary embodiment of the present invention has two or more lines, through which facsimile information can be independently transmitted.

Referring to FIG. 1, the image forming apparatus 100 having a facsimile machine receives facsimile information through a public switched telephone network (PSTN). The image forming apparatus 100 further includes a discharging unit (see “20” of FIG. 2) to discharge a printing medium having an image of the received facsimile information formed thereon. As the image forming apparatus 100 is equipped with a facsimile machine having two or more lines, it receives two or more sets of facsimile information through the two or more lines. Images of the two or more sets of facsimile information are formed on two or more pieces of the printing medium through the image forming unit 60 of the image forming apparatus 100 and then discharged through the discharge unit 20.

For example, facsimile information received through Line “A” and facsimile information received through Line “B” are respectively printed on sheets of paper in the image forming unit of the image forming apparatus 100 and thereafter discharged. The printed paper based on the facsimile information received through Line “A” and the printed paper based on the facsimile information received through Line “B” are loaded on the discharge unit 20 in such a manner to be sorted out for the user's convenience.

The image forming apparatus 100 further includes a paper feeding unit (see “10” of FIG. 2) to feed paper to form an image of the received facsimile information thereon. The paper feeding unit 10 of this exemplary embodiment may include a paper feeding tray to load papers to be fed thereon. In addition, the discharging unit 20 of this exemplary embodiment may include a paper discharging tray to load discharged papers thereon.

An embodiment of the present invention exemplifies an image forming apparatus 100 having a single paper feeding tray (see “10” of FIG. 2) feeding a paper (see “P” of FIG. 2) and a single paper discharging tray (see “20” of FIG. 2) discharging the paper P having images formed thereon. The image forming apparatus 100 enables a user to easily distinguish the printed paper by each line in the single paper discharging tray (see “20” of FIG. 2), by discharging the paper P using a paper returning path (see “C” of FIG. 2), for example, a path to print both-sides of the paper to be described later (hereinafter, “both-side printing path”).

FIG. 2 denotes a transporting path by “A” and a returning path by “C” as paths to print the paper P within the image forming apparatus 100. The paper transporting path A of the image forming apparatus 100 will first be described. The paper transporting path A corresponds to, for example, a one-sided printing of the paper P. The image forming apparatus 100 of this exemplary embodiment may further include a pickup roller 7 picking up the paper P loaded on the paper feeding unit 10 one by one, transporting rollers 23 and 28 transporting the picked-up paper P, a heating roller 41 and a pressing roller 42 heating and pressing a toner image on the paper P, a paper discharge sensor 44 sensing the paper P in order to discharge the paper P, and a pair of paper discharge rollers 63 and 64 discharging the paper P forming the image thereon. The image forming unit 60 may include an image bearing body 32 on which an afterimage is formed based on the image data, and a transferring roller 66 transferring the toner image onto the paper P.

Referring to FIG. 2, the paper loaded on the paper feeding unit 10 is transported to the image forming unit 60 one by one through the pickup roller 7 and the transporting rollers 23 and 28. An image is formed on one side of the paper P, that is, a side opposite to the image bearing body 32, by the image bearing body 32 and the image transferring roller 66. The paper P on which the image is formed is discharged to the discharging unit 20 through the paper discharge sensor 44 and the pair of paper discharge rollers 63 and 64 after a toner image is fixed to the paper P through a fusing unit comprising the heating roller 41 and the pressing roller 42. In case of one-sided printing, the paper P is discharged through the paper transporting path A, that is, a printing path, after an image is formed.

Next, the paper returning path C of the image forming apparatus will be described. The paper returning path C is different from the paper transporting path A, and may be used when printing both sides of the paper P, in which case the paper returning path may also be referred to as the “two-sided printing path.” The image forming apparatus 100 may further include a flapper 54 guiding a transporting direction of the paper P and a reverse transporting roller 70 transporting the paper P along the paper returning path C.

For the two-sided printing, the image forming apparatus reversely transports the paper P that has an image formed one side towards the reverse transporting roller 70 without discharging the paper P to the discharging unit 20 by driving the paper discharge rollers 63 and 64 reversely. That is, the paper P is directed into the paper returning path C on which the reverse transporting roller 70 is positioned, i.e., the two-sided printing path, through the flapper 54 guiding a reverse driving of the paper discharge rollers 63 and 64 and the transporting direction of the paper. After then, at the end of the paper returning path C, the paper P enters into the paper transporting path A, and is moved to a point in the upstream of paper transporting path A with respect to the transporting direction of the paper P (near the transporting roller 28). The paper P that enters into the paper transporting path A after passing through the paper returning path C is in a reversed orientation such that when the paper P passes through the image forming unit 60, an image is formed on a side of the paper P opposite to the side on which an image is formed by a first passing through the paper transporting path A. Then, the paper P is discharged to the discharging unit 20 through the fusing units 41 and 42 and the paper discharge rollers 63 and 64.

The image forming apparatus 100 according to one exemplary embodiment of the present invention uses the characteristics of the paper transporting path A and the paper returning path C as described above, to allow the paper P having one side having an image formed thereon (hereinafter referred to as “printed side”) to be directed towards different directions with respect to two incoming lines of the facsimile machine when the paper P is loaded on the discharging unit 20. That is, the image forming apparatus 100 directs the printed side of the paper P to a first direction with respect to one of the two incoming lines of the facsimile machine and the printed side of the paper P to a second direction with respect to the other incoming line, different from the first direction, when the paper is loaded on the discharging unit 20. With respect to the first direction, the printed side of the paper P may be directed downward when loaded on the discharging unit 20 so that the paper P is not exposed from the viewpoint of the user, but with respect to the second direction, the printed side of the paper P may be directed upward to be exposed.

If an image is formed on one side of the paper P through the paper transporting path A and the paper P is directly loaded on the discharging unit 20, the printed side of the paper P is oriented in the same direction as it would be with one-sided printing. If the paper P is redirected into the image forming unit 60 through the paper returning path C after an image is formed on the one side through the paper transporting path and if the image forming apparatus 100 is controlled so as not to form an image on the reverse side of the paper P in the image forming unit 60, the printed side of the paper P discharged to the discharging unit 20 is in a flipped-over orientation compared to the orientation of the paper P in the regular one-sided printing.

As described above, if the paper transporting path A and the paper returning path C are used, the orientation of the printed side of the paper P discharged to the discharging unit 20 can be different. Thus, even if the image forming apparatus 100 has only a single discharging unit 20, printed papers directed through only the paper transporting path A and printed papers further directed through the paper returning path C can be easily distinguished. That is, if the facsimile printouts received by each incoming line are discharged from the single discharging unit 20 by putting the printed sides in different orientations using the paper transporting path A and the paper returning path C, the user can easily recognize which facsimile printouts correspond to which incoming line.

For example, if the facsimile information is received through Line “A,” the image forming apparatus 100 is controlled so that the paper P is discharged after passing from the paper feeding unit 10 to the paper transporting path A, where an image is formed on one side of the paper P and to the discharging unit 20 in sequence. If the facsimile information is received from Line “B,” the image forming apparatus 100 is controlled so that the paper P is discharged after passing from the paper feeding unit 10 to the paper transporting path A, where an image is formed on one side of the paper P and then through the paper returning path C, the paper transporting path A again (without forming an image on the reverse side of the paper P) and the discharging unit in sequence. As an example, the facsimile printout of the facsimile information received through Line A may be discharged to the discharging unit 20 such that the printed side is directed downward (the first direction) based on FIG. 2, and the facsimile printout through Line “B” may be discharged to the discharging unit 20 such that the printed side is directed upward (the second direction). Accordingly, the user can easily recognize which incoming line each discharged facsimile printouts is from, thereby increasing the user's convenience. In the case of two-sided printing, the method described above would make it difficult for a user to distinguish facsimile printouts from different incoming lines based on the printing orientation. Thus, a two-sided printing function may be inactivated where an image is formed on the paper P based on facsimile information. Where the two-sided printing function according to this exemplary embodiment is inactive, the image of the facsimile information is formed only on one side of the paper P even though both the paper transporting path A and the paper returning path C are used.

As another exemplary embodiment of the present invention, a problem of how to distinguish facsimile printouts from two incoming lines, in the case where an image is formed on both sides of the paper based on the facsimile information, can be solved through the following method: The image forming apparatus 100 according the present invention rotates an image formed on the paper P differently with respect to facsimile information coming from different incoming lines. That is, the image forming apparatus 100 sets a rotation angle of an image formed on the paper P to a first angle with respect to one of the two incoming lines and sets the rotation angle to a second angle with respect to the other incoming line, wherein the first angle is different from the second angle. For example, the image forming apparatus 100 may form an image of the facsimile information on the paper P without rotating the image with respect to the facsimile information that is received through Line “A” and may form an image of the facsimile information on the paper P with rotation by 180 degrees of the original image with respect to the facsimile information that is received through Line “B.”

For two-sided printing of the paper P, the image forming apparatus 100 controls the control unit (see “30” of FIG. 2) to form an image based on the facsimile image information through Line “A” on both sides of the paper based on the received image information, and to form an image based on the second facsimile information with rotating the received image information by 180 degrees, if the facsimile image information is received through Line “B.” Thus, the user can easily know which line the facsimile printouts discharged to the discharging unit 20 originate from. The content of facsimile image information according to this embodiment may include text as well as images such as pictures and photos, etc.

In the exemplary embodiment described above, the angle of rotation for an image based on the second facsimile information is not limited to 180 degrees. For example, an image can be formed based on facsimile information that is rotated by 90 degrees. The method described above can be applied to one-sided printing as well as two-sided printing. In case of the one-sided printing, it is not necessary for the paper to pass through the paper returning path C. The rotation of the facsimile information in forming the printed image can be accomplished while the paper passes through the paper transporting path A, that is, the printing path.

As another embodiment to distinguish a two-sided printed paper based on facsimile information received from a first incoming line and a two-sided printed paper based on facsimile information received from a second incoming line, an image based on facsimile information received through line “A” may formed on both sides of the paper P while the paper P passes from the paper feeding unit 10 to the paper transporting path A and the two-sided printing path C such that the facsimile information received through Line “A” is printed on both sides of the paper, and is then discharged passing through the paper transporting path A and the discharging unit C in turn. Where the facsimile information received through Line “B” is printed on both sides of the paper, the paper passes from the paper feeding unit 10 to the paper transporting path A and the both-side printing path C, such that an image is formed on the both-sides of the paper P and then can be discharged by passing through the paper transporting path A, the two-sided printing path C, the paper transporting path A and the discharging unit 20 in return. That is, the facsimile printout based on facsimile information received from Line “B” passes through the two-sided printing path C and the paper transporting path A one additional time compared to the facsimile printout based on facsimile information received from Line A, and thus, the facsimile printout based on facsimile information received through Line A has a first page whose printed side is directed upward, whereas the facsimile printout based on facsimile information received through Line “B” has a second page whose printed side is directed upward. As a result, the user can easily recognize from which line the facsimile printout is output.

As another embodiment, a line-based distinguishing method in the facsimile machine can be used to distinguish the outputs by facsimile, printer or photocopier as well as distinguish the facsimile printout from each line. That is, using this method enables the user to easily distinguish printouts whether they are received through a facsimile machine, output through a printing machine, output through a printing command, or output through a photocopying command, etc.

For example, when an image is formed on paper based on the facsimile function, the paper may be discharged after passing from the paper feeding unit 10 through the paper transporting path A and the discharging unit in turn, as the image is formed thereon. Where an image is formed on paper based on the printing or the photocopying function, different from the facsimile function, the paper may pass from the paper feeding unit 10 through the paper transporting path A, at which time an image is formed on the paper and then may be discharged by passing through the paper returning path C, the paper transporting path A and the discharging unit in turn.

Alternatively, where an image is formed on paper based on the printing or photocopying function, the paper may be discharged after passing from the paper feeding unit 10 through the paper transporting path A and the discharging unit 20 in turn as an image is formed thereon and where an image is formed on paper based on the facsimile function, the paper may pass from the paper feeding unit 10 through the paper transporting path A, at which time an image is formed on the paper, and then may be discharged by passing through the paper returning path C, the paper transporting path A and the discharging unit 20.

The above-described identification methods to distinguish papers printed according to two more incoming lines or according to a function such as facsimile printing or photocopying can be performed by the control unit 30 of the image forming apparatus shown in FIG. 2. The control unit 30 may control at least one of the pickup roller 7, the transport rollers 23 and 28, the heating roller 41, the pressing roller 42, the paper discharge sensor 44, the paper discharge rollers 63 and 64, and the image forming unit 60, to perform operations at each embodiment. The control unit 30 may comprise a non-volatile memory (not shown) such as ROM in which a corresponding control program is stored, a volatile memory (not shown) such as RAM loading thereon at least a portion of the control program stored in the non-volatile memory, and a microprocessor (not shown) such as CPU performing the control program loaded in the volatile program.

Although a few exemplary embodiments of the present invention have been illustrated and described in details, the present invention is not limited thereto, and can be carried out in various manners, within the scope of the claims. Moreover, it is to be appreciated by those skilled in the art that changes may be made in this embodiment without departing from the principles and spirit of the invention, the scope of which is defined in the claims and their equivalents.

What is claimed is:

1. An image forming apparatus equipped with a facsimile machine having two or more incoming lines, comprising:
a paper feeding unit that feeds a paper;
an image forming unit that forms an image on the paper;
a discharging unit that discharges the paper on which the image is formed;
a paper transporting path on which the image forming unit is positioned, the paper transporting path extending from the paper feeding unit to the discharging unit; and
a paper returning path that extends from the discharging unit to a point in the paper transporting path that is upstream of the image forming unit with respect to a movement direction of the paper,
wherein if first facsimile information is received through a first line of the two or more incoming lines, the paper on which an image of the first facsimile information is formed passes from the paper feeding unit through the paper transporting path, where the image of the first facsimile information is formed, to the discharging unit, and
if second facsimile information is received through a second line of the two or more incoming lines, different from the first line, the paper on which an image of the second facsimile information is formed passes from the paper feeding unit through the paper transporting path, where the image of the second facsimile information is formed, and then through the paper returning path, the paper transporting path a second time and to the discharging unit.

2. The image forming apparatus of claim 1, wherein the paper returning path provides a two-sided printing functionality to form an image on two sides of the paper.

3. The image forming apparatus of claim 2, wherein the two-sided printing functionality is set to be inactive.

4. The image forming apparatus of claim 1, wherein the facsimile machine has two incoming lines.

5. The image forming apparatus of claim 1, further including a control unit that determines whether facsimile information received by the image forming apparatus is first facsimile information received through a first line of the two or more incoming line or second facsimile information received through a second line of the two or more incoming lines and that controls a paper path of the paper on which the image is formed according to whether the facsimile information received by the image forming apparatus is the first facsimile information or the second facsimile information.

6. A method of operating an image forming apparatus that receives printing information from a first source and a second source and that discharges papers having an image formed thereon based on the received printing information to a single discharging tray, the method comprising:
determining whether printing information received by the image forming apparatus is from the first source or the second source;
if the printing information is determined to be from the first source, forming an image on a paper according to the printing information from the first source and discharging the paper having the image according to the printing information from the first source formed thereon to the single discharging tray; and
if the printing information is determined to be from the second source, forming an image on a paper according to the printing information from the second source and discharging the paper having the image according to the printing information from the second source formed thereon to the single discharging tray,
wherein the forming of the image on a paper according to the printing information from the second source or the discharging of the paper having the image according to the printing information from the second source formed thereon is carried out such that the paper having the image according to the printing information from the second source is distinguishably oriented in the single discharging tray with respect to a paper having an image according to the printing information from the first source.

7. The method of claim 6, wherein the discharging of the paper having the image according to the printing information from the first source formed thereon includes directing the paper having the image according to the printing information from the first source formed thereon to the discharging tray in a first orientation and wherein the discharging of the paper having the image according to the printing information from the second source includes directing the paper having the image according to the printing information from the second source formed thereon through a paper returning path such that the paper having the image according to the printing information from the second source is discharged in a flipped orientation with respect to the paper having an image according to the printing information from the first source.

8. The method of claim 6, wherein the first source of printing information is a first incoming line of a facsimile function of the image forming apparatus and the second source of printing information is a second incoming line of the facsimile function.

9. The method of claim 6, wherein the first source of printing information is local printing information from a photocopying function or a printing function and wherein the second source of printing information is an incoming line of a facsimile function.

10. An image forming apparatus equipped with a facsimile machine having two or more incoming lines, comprising:
a paper feeding unit that feeds a paper;
an image forming unit that forms an image on the paper;
a control unit that controls the image forming unit to form an image with respect to image information received from the facsimile machine on the paper;
a discharging unit that discharges the paper on which the image is formed;
a paper transporting path on which the image forming unit is positioned, the paper transporting path extending from the paper feeding unit to the discharging unit; and
a two-sided-printing path that extends from the discharging unit to a point in the paper transporting path that is upstream of the image forming unit with respect to a movement direction of the paper, such that a paper that has passed through the image forming unit a first time is directed to pass through the image forming unit a second time such that an image is formed on both sides of the paper,
wherein if an image with respect to first image information received through a first line of the two or more incoming lines is formed on both sides of the paper, the control unit controls the image forming unit to form the image thereof on both sides of the paper based on the received first image information, and
if an image with respect to second image information received through a second line of the two or more incoming lines, which is different from the first line, is formed on both sides of the paper, the control unit controls the image forming unit to form the image thereof on both sides of the paper based on third image information, which is rotated from the received second image information by 180 degrees.

11. An image forming apparatus equipped with a facsimile machine having two or more incoming lines, comprising:
a paper feeding unit that feeds a paper;
an image forming unit that forms an image on the paper;
a control unit that controls the image forming unit to form an image with respect to image information received from the facsimile machine on the paper;
a discharging unit that discharges the paper on which the image is formed, wherein if first image information to be printed is received through a first line of the two or more incoming lines, the control unit controls the image forming unit to form an image thereof on the paper based on the received first image information, and
if second image information to be printed is received through a second line of the two or more incoming lines, which is different from the first line, the control unit controls the image forming unit to form an image thereof on the paper based on third image information, which is rotated from the received second image information by 180 degrees.

12. An image forming apparatus having two or more functions of printing, photocopying and faxing, comprising:
a paper feeding unit that feeds a paper;
an image forming unit that forms an image on the paper;
a discharging unit that discharges the paper on which the image is formed;
a paper transporting path on which the image forming unit is positioned, the paper transporting unit extending from the paper feeding unit to the discharging unit; and
a paper returning path that extends from the discharging unit to a point in the paper transporting path that is upstream of the image forming unit with respect to a movement direction of the paper,
wherein if an image is formed on the paper based on the facsimile function, the paper on which the image is formed passes from the paper feeding unit through the paper transporting path, where the image is formed based on the facsimile function, to the discharging unit, and
if an image is formed on the paper based on the printing or photocopying function other than the facsimile function, the paper on which the image is formed passes from the paper feeding unit through the paper transporting unit, where the image based on the printing or photocopying function is formed, and then through the paper returning path, through the paper transporting path a second time and to the discharging unit.

13. An image forming apparatus equipped with a facsimile machine having two or more incoming lines, comprising:
a paper feeding unit that feeds a paper;
an image forming unit that forms an image on the paper;
a discharging unit that discharges the paper on which the image is formed;
a paper transporting path on which the image forming unit is formed, the paper transporting path extending from the paper feeding unit to the discharging unit; and
a two-sided-printing path that extends from the discharging unit to a point in the paper transporting path that is upstream of the image forming unit with respect to a movement direction of the paper, such that a paper that has passed through the image forming unit a first time is directed to pass through the image forming unit a second time such that an image is formed on both sides of the paper,
wherein if facsimile information received from a first line of the two or more lines is printed on both sides of the paper, the image is formed on both-sides of the paper passing through the paper feeding unit, the paper transporting path and the both-side printing path, and the paper is then discharged passing through the paper transporting path and the discharging unit in turn, and
where if facsimile information received from a second line of the two or more lines, which is different from the first line, is printed on both sides of the paper, the image is formed on both-sides of the paper passing through the paper feeding unit, the paper transporting path and the both-side printing path, and the paper is then discharged passing through the paper transporting path, the both-side printing path, the paper transporting path and the discharging unit in turn.

14. An image forming apparatus having two or more functions of printing, photocopying and faxing, comprising:
a paper feeding unit that feeds a paper;
an image forming unit that forms an image on the paper;
a discharging unit that discharges the paper on which the image is formed;
a paper transporting path on which the image forming unit is formed, the paper transporting path extending from the paper feeding unit to the discharging unit; and
a paper returning path that extends from the discharging unit to a point of the paper transporting path that is upstream of the image forming unit with respect to the movement direction of the paper,
wherein if an image is formed on the paper based on printing or photocopying function, the paper on which the image is formed passes from the paper feeding path through the paper transporting path, where the image based on the printing or photocopying function is formed, to the discharging unit, and
if an image is formed on the paper based on the facsimile function, the image is formed on the paper passing from the paper feeding unit through the paper transporting path, and the paper then passes through the paper returning path, the paper transporting path and the discharging unit.
